(19) United States
(12) Patent Application Publication
(10) Pub. No.: US 2017/0102837 A1
(43) Pub. Date: Apr. 13, 2017

(54) DYNAMIC CONTROL OF PLAYLISTS USING WEARABLE DEVICES

(71) Applicant: SPOTIFY AB, STOCKHOLM (SE)

(72) Inventor: Nikolaos Toumpelis, Stockholm (SE)

(21) Appl. No.: 15/183,685

(22) Filed: Jun. 15, 2016

Related U.S. Application Data
(60) Provisional application No. 62/238,635, filed on Oct. 7, 2015.
(60) Provisional application No. 62/350,607, filed on Jun. 15, 2016.

(51) Int. Cl. G06F 3/0482; G06F 3/14; G06F 3/0488; H04W 12/08; H04W 4/00

(52) U.S. Cl. CPC G06F 3/0482; H04W 12/08; H04W 4/008; G06F 3/04883; G06F 3/1454; H04W 4/023

(57) ABSTRACT

A second electronic device performs a method of controlling the manipulation of a playlist hosted by the second electronic device. In the method, geographic information that is indicative of a geographic location of a first electronic device is accessed. Based on the geographic information, the second electronic device determines whether the first and second electronic devices are located within a defined geographic proximity. In response to a determination that the first and second electronic devices are located within the defined geographic proximity, the first electronic device is authorized to manipulate the playlist.

### RELATED PATENT APPLICATIONS

This patent application claims priority to U.S. Provisional Patent Application Nos. 62/238,635, filed on Oct. 7, 2015, entitled “Dynamic Control of Playlists,” and 62/350,607, filed Jun. 15, 2016, entitled “Dynamic Control of Playlists using Wearable Devices,” which are expressly incorporated herein by reference in their entirety.

### TECHNICAL FIELD

The present disclosure generally relates to the provision of media, and more particularly to the streaming of media. In particular, the embodiments described herein relate to methods and systems (e.g., servers, mobile electronic devices, wearable devices and media presentation systems) which may be used for dynamically controlling a playlist and for presenting media items of this playlist to one or more users.

### BACKGROUND

As computer technology has improved, the digital media industry has evolved greatly in recent years. Users are able to use electronic devices such as mobile communication devices (e.g., cellular telephones, mobile telephones, smart phones, tablet computers (also known as tablets), etc.) to consume media content such as music, video, etc. For instance, users can listen to audio content (e.g., music) and/or watch video content (e.g., movies, television (TV) broadcasts, etc.) on a variety of electronic devices.

At the same time, advances in network technology have increased the speed and reliability with which information can be transmitted over computer networks. It is therefore possible for users to stream media content over computer networks as needed, or on demand, rather than receiving a complete file in physical media (such as a CD, or downloading the entire file) before consuming the media content.

At social gatherings such as parties, users often wish to share media content with friends, relatives, and new acquaintances. For example, a party host may access media content on a portable electronic device, such as a mobile phone or a tablet computer, and present media content through a media presentation system (e.g., play music on one or several speakers or stream video on a screen).

### SUMMARY

It is in view of the above considerations and others that the various embodiments disclosed herein have been made.

It is a general object of the embodiments described herein to allow for an improved way of controlling playback of media, such as music, e.g. at social gatherings.

In a first of its aspects, this disclosure concerns a method of controlling the manipulation of a playlist hosted by a second electronic device. The method is performed by the second electronic device. The second electronic device may for example comprise a processor, a memory, a user interface and a communications interface (e.g., including transmission (Tx) and/or reception (Rx) functionality). Geographic information that is indicative of a geographic location of a first electronic device is accessed. It is then determined, based on the geographic information, whether the first and second electronic devices are located within a defined geographic proximity. In response to a determination that the first and second electronic devices are located within the defined geographic proximity, the first electronic device is authorized to manipulate the playlist.

In some embodiments, accessing the geographic information that is indicative of the geographic location of the first electronic device comprises sensing that the first electronic device is located within the defined geographic proximity. For example, sensing that the first electronic device is located within the defined geographic proximity may comprise utilizing a wireless short-range communication technology (e.g., wireless local-area-network (WLAN) technology or wireless personal-area-network (PAN) technology). In some embodiments, sensing that the first electronic device is located within the defined geographic proximity comprises using Bluetooth proximity sensing technology. Additionally, or alternatively, sensing that the first electronic device is located within the defined geographic proximity may comprise using Wi-Fi proximity sensing technology.

In some embodiments, the method additionally comprises, after authorizing the first electronic device to manipulate the playlist, generating an updated order of media items in the playlist in response to receiving a request from either the first electronic device or the second electronic device to manipulate the playlist. In some embodiments, the method additionally comprises, after authorizing the first electronic device to manipulate the playlist, generating an updated order of media items in the playlist in response to receiving a request from the first electronic device to manipulate the playlist. In some embodiments, the method additionally comprises, after authorizing the first electronic device to manipulate the playlist, generating updated orders of media items in the playlist in response to receiving respective requests from both the first electronic device and the second electronic device to manipulate the playlist

Furthermore, the method may additionally comprise (prior to authorizing the first electronic device to manipulate the playlist) receiving, from the first electronic device, a signal being indicative of the first electronic device requesting authorization to control the manipulation of the playlist.

In some embodiments, the method may also include the following actions (or, steps):
in response to detecting a first control gesture at a user interface of the second electronic device, interpreting the first control gesture to be an instruction to approve the request of the authorization to control the manipulation of the playlist, and in response thereto authorizing the second electronic device to manipulate the playlist; else
in response to detecting a second control gesture at the user interface of the second electronic device, interpreting the second control gesture to be an instruction to disapprove the request of the authorization to control the manipulation of the playlist; and in response thereto rejecting the second electronic device from manipulating the playlist.

For example, the first control gesture may be a tap gesture, a swipe gesture, or a hovering gesture. Additionally, or alternatively, the second control gesture may be a tap gesture, a swipe gesture, or a hovering gesture.

In some embodiments, the method may also include receiving multiple requests for authorization to control the manipulation of the playlist. For example, a first request is received from the first electronic device and a second request is received from a third electronic device. In another example, first and second requests are received from the first electronic device. The first request is approved, and the corresponding electronic device authorized to manipulate the playlist, in response to detecting a first control gesture at a user interface of the second electronic device. The second request is denied, and the corresponding electronic device is prevented from manipulating the playlist, in response to detecting a second control gesture at the user interface of the second electronic device.

Furthermore, the second electronic device may be a mobile electronic device, such as a mobile phone, a smart phone, a tablet computer, a media player, or the like. Alternatively, the second electronic device may be a stationary electronic device, such as a desktop computer.

Likewise, the first electronic device may be a mobile electronic device, such as a mobile phone, a smart phone, a tablet computer, a media player, or the like. Alternatively, the first electronic device may be a stationary electronic device, such as a desktop computer.

In a second of its aspects, this disclosure concerns a method of remotely controlling the manipulation of a playlist hosted by a second electronic device. The method is performed by a wearable device (e.g., a computerized wristwatch or wristwatch-like device), which is associated with a first electronic device. As will be appreciated, the wearable device may be a device which is communicatively connectable to the first electronic device to access one or more functionalities hosted by the first electronic device. The wearable device may include a processor, a memory, a user interface and a communications interface (e.g., including transmission (Tx) and/or reception (Rx) functionality).

A signal is sent, i.e. transmitted, to the first electronic device. This signal is indicative of the wearable device requesting authorization to control the manipulation of, and thus to manipulate, the playlist hosted by the second electronic device. In response to receiving this signal, the first electronic device may send a signal to the second electronic device for requesting authorization to control the manipulation of the playlist hosted by the second electronic device.

Furthermore, an acknowledgement (ACK) signal may be received from either or both of the first and second electronic devices. The ACK signal is indicative of the second electronic device having approved the request for authorization to control the manipulation of the playlist hosted by the second electronic device. Accordingly, a user interface of the wearable device may subsequently be enabled to present the playlist hosted by the second electronic device for subsequent manipulation of the earlier-mentioned playlist.

Alternatively, a non-acknowledgement (NACK) signal may be received from either or both of the first and second electronic devices. The NACK signal is indicative of the second electronic device having disapproved the request for authorization to control the manipulation of the playlist hosted by the second electronic device.

In a third of its aspects, this disclosure concerns a second electronic device, comprising a user interface, a communications interface, one or more processors, and a memory storing instructions executable by the one or more processors whereby the second electronic device is operative to perform the method according to the earlier-described first aspect. Again, the second electronic device may be a mobile electronic device, such as a mobile phone, a smart phone, a tablet computer, a media player, or the like. Alternatively, the second electronic device may be a stationary electronic device, such as a desktop computer.

In a fourth of its aspects, this disclosure concerns a wearable device, comprising a user interface, a communications interface, one or more processors, and a memory storing instructions executable by the processor whereby the second electronic device is operative to perform the method of the earlier-described second aspect.

In a fifth of its aspects, this disclosure concerns a non-transitory computer-readable storage medium storing one or more sets of instructions for causing a processor to perform the method according to the earlier-described first aspect.

In a sixth of its aspects, this disclosure concerns a non-transitory computer-readable storage medium storing one or more sets of instructions for causing a processor to perform the method according to the earlier-described second aspect.

Various embodiments described herein enable a user of a wearable device, e.g. a computerized wristwatch or wristwatch-like device, to remotely control a queue of playable media items (e.g., songs) of a playlist, which is associated with a different, i.e. the second, electronic device. The authorization to control the playlist using the wearable device is determined based on the proximity between the second electronic device and a first electronic device to which the wearable device is associated (e.g., paired via wireless short-range communication). Embodiments described herein thus enable a user of the wearable device to control another user's playlist when these users (and their respective electronic devices) are proximate to one another. This, in turn, may lead to improved user experiences, e.g. at social gatherings such as parties.

### BRIEF DESCRIPTION OF DRAWINGS

These and other aspects, features and advantages will be apparent and elucidated from the following description of various embodiments, reference being made to the accompanying drawings, in which:

FIG. 1A is a block diagram schematically illustrating an media content delivery system in accordance with some embodiments;

FIG. 1B shows an example scenario at a social gathering in accordance with some embodiments;

FIG. 2 illustrates a system for playback of a media content stream and/or dynamic control of a queue of playable media items, in accordance with some embodiments;

FIG. 3A shows a signaling diagram schematically illustrating communications between various devices in accordance with some embodiments;

FIG. 3B shows an example scenario at the social gathering of FIG. 1B;

FIG. 4 schematically illustrates a flowchart of a method performed by an electronic device in accordance with some embodiments;

FIG. 5 schematically illustrates a flowchart of a method performed by a wearable device in accordance with some embodiments;

FIGS. 6A-6C schematically illustrate different views of an example of a user interface of a wearable device such as a computerized wristwatch or wristwatch-like device;

FIG. 7 schematically illustrates example embodiments of user interfaces of a second electronic device and a wearable device, respectively;

FIG. 8 shows an example of a second electronic device;

FIG. 9 illustrates a carrier comprising a computer program, in accordance with some embodiments; and

FIG. 10 shows an example of some embodiments of a wearable device.

### DETAILED DESCRIPTION

Various embodiments will now be described more fully hereinafter. The disclosure may, however, be embodied in many different forms and should not be construed as limited to the embodiments set forth herein; rather, these embodiments are provided by way of example so that this disclosure will be thorough and complete, and will fully convey the scope of the disclosure to those persons skilled in the art. Like reference numbers refer to like elements or method steps throughout this description and the drawings.

A wearable device (e.g., a computerized wristwatch or wristwatch-like device) may be operated to remotely control the manipulation of a playlist hosted by a nearby second electronic device. The wearable device may be configured to send a signal to a first electronic device to which the wearable device is associated (e.g., paired using wireless short-range communication such as Bluetooth or another wireless PAN protocol). This signal is indicative of the wearable device requesting authorization to control the manipulation of the playlist hosted by the second electronic device.

In response to receiving this signal, the first electronic device may indicate (e.g., by transmitting an explicit request signal) to the second electronic device that it requests authorization to control the manipulation of the playlist hosted by the second electronic device.

The second electronic device may be configured to access geographic information that is indicative of a geographic location of the first electronic device. In some embodiments, accessing the geographic information that is indicative of the geographic location of the first electronic device comprises sensing that the first electronic device is located within a defined geographic proximity. For example, sensing that the first electronic device is located within the defined geographic proximity may comprise utilizing a wireless communication technology (e.g., a short-range wireless technology, for example Bluetooth/PAN proximity sensing technology and/or Wi-Fi/WLAN proximity sensing technology). The geographic location of the first electronic device is generally also a suitable indication of the geographic location of the wearable device. The wearable device is typically communicatively connected (i.e., paired) to the first electronic device to access various functionalities hosted by the first electronic device. This is typically achieved using wireless short-range communication technologies such as Bluetooth and, hence, the wearable device is typically located in proximity to its host device (i.e., the first electronic device) when the wearable device is communicatively connected (i.e., paired) to the host device. Based on the accessed geographic information of the first electronic device, the second electronic device is configured to determine whether the first and second electronic devices are located within a defined geographic proximity. For example, the second electronic device is configured to determine whether the first and second electronic devices are proximate to each other. In response to a determination that the first and second electronic devices are located within the defined geographic proximity (e.g., proximate to each other), the second electronic device authorizes the first electronic device to manipulate the playlist, i.e. the playlist that is hosted by the second electronic device.

This way, it is made possible to enable a user of a wearable device, e.g. a computerized wristwatch or wristwatch-like device, to remotely control a queue of playable media items (e.g., songs) of a playlist, which is associated with a different, i.e. a second, electronic device. The authorization to control the playlist using the wearable device is determined based on the proximity between the second electronic device and a first electronic device to which the wearable device is associated (e.g., paired via wireless short-range communication). Embodiments described herein thus enable a user of the wearable device to control another user's playlist when these users (and their respective electronic devices) are proximate to one another. This, in turn, may lead to improved user experiences, e.g. at social gatherings such as parties.

This has the further effect that users of electronic devices can remotely control each other's playlists of media items when the users (and their respective electronic devices) are proximate to one another. In an example scenario at a social gathering, e.g. a party, several users (and their respective electronic devices) may be proximate to each other and all users (and their respective electronic devices) that are located within a defined geographic proximity to the second electronic device may be authorized to control the playlist associated with the second electronic device. In this way, several users may control (e.g. collaboratively control) the queue of playable media items to be played at the social gathering. This may lead to improved user experiences at social gatherings.

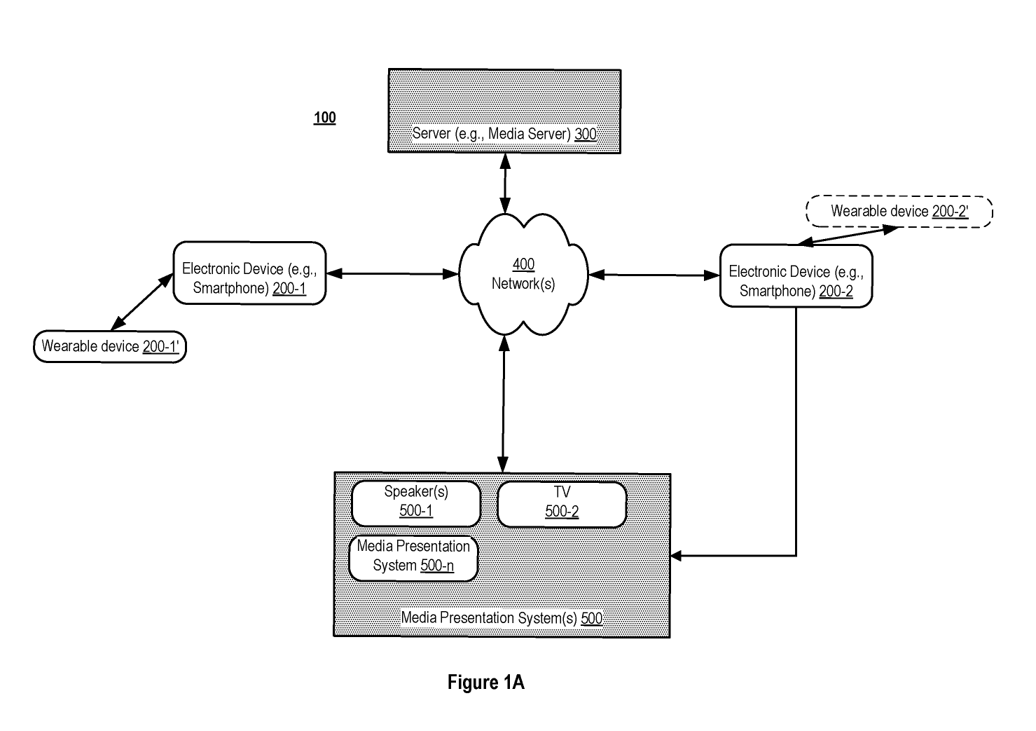

In order to give context to the various embodiments described in this disclosure, FIG. 1A schematically illustrates a media content delivery system 100 in accordance with some embodiments. The media content delivery system 100 may comprise several electronic devices 200 (e.g., first electronic device 200-1 and second electronic device 200-2), one or more servers 300 (e.g., computer server(s) such as media content server(s) (sometimes referred to as media server(s))), and one or more media presentation systems (e.g., media presentation systems 500 including speaker(s) 500-1, television (TV) 500-2, and/or other media presentation systems 500-n). Furthermore, a wearable device 200-1′ may be communicatively connected to the first electronic device 200-1 as is schematically illustrated in FIG. 1A. For example, the wearable device 200-1′ may be paired to the first electronic device 200-1 using wireless short-range communication technology (e.g., Bluetooth or another wireless PAN protocol). Likewise, a wearable device 200-2′ may optionally be communicatively connected to the second electronic device 200-2.

In some embodiments, the electronic device 200 may be a mobile telephone, such as a smart phone. Alternatively, the electronic device 200 may be a tablet computer. In yet other embodiments, the electronic device 200 may be any other electronic device capable of playback of media content such as, for example, one of the electronic devices of the following group: a personal computer, a desktop computer, a laptop computer, and a mobile electronic device (e.g. a handheld entertainment device, a digital media player, or other media device).

One or several networks (e.g., network(s) 400) may communicatively connect each component of the media content delivery system 100 with other components of the media content delivery system 100. The network(s) 400 may include public communications networks, private communication networks or a combination of both public and private communication networks. For example, the networks(s) may include any network(s) such as the Internet, other wide area networks (WAN), wireless wide area networks (WWAN), local area networks (LAN), wireless local area networks (WLAN), virtual private networks (VPN), metropolitan area networks (MAN), peer-to-peer networks, and/or ad-hoc networks. As will also be appreciated, the network(s) 400 may thus comprise cellular telecommunications network(s) and/or non-cellular network(s).

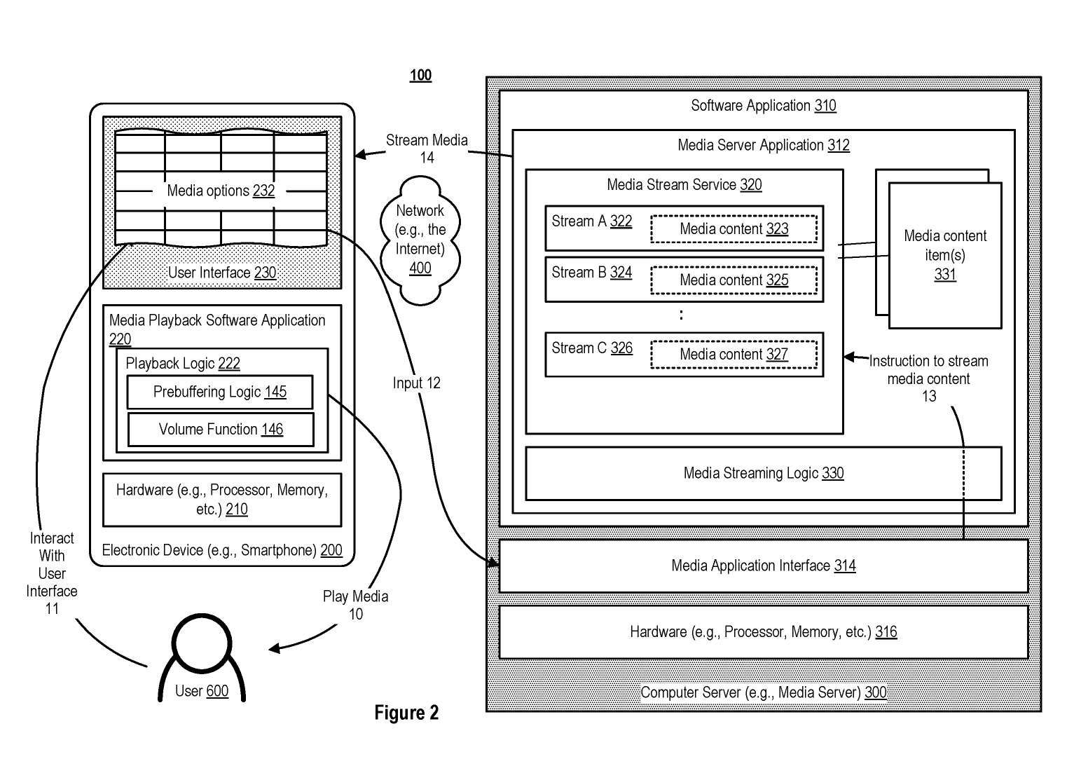

In some embodiments, as is illustrated in FIG. 1A, an electronic device 200 (e.g., the second electronic device 200-2 in the following example) may be capable of remotely controlling one or more of the media presentation systems 500. To this end, the second electronic device 200-2 may for example implement, or otherwise utilize, any of the techniques described in the international patent application PCT/IB2013/001938 (published under WO2014/001913A2) and corresponding U.S. Pat. No. 9,195,383. For example, it is possible for a user of the second electronic device 200-2 to remotely control the presentation of media at any one or a combination of the media presentation systems 500. WO2014/001913A2 and U.S. Pat. No. 9,195,383 are incorporated herein by reference in their entirety. The second electronic device 200-2 may receive a media control command for a media presentation system 500 (e.g. speaker(s) 500-1). In response to receiving this media control command, the second electronic device 200-2 may transmit a server media control request to the server 300 and a local media control request to the media presentation system 500, which may located be within the same local network, e.g. a LAN, as the second electronic device 200-2 (i.e., a local network to which both the second electronic device 200-2 and the media presentation system 500 are connected). The server media control request may e.g. be sent to the server 300 over the Internet. Typically, but not necessarily, the server 300 is associated with an Internet Protocol (IP) address outside the space of the local network to which both the second electronic device 200-2 and the media presentation system 500 are connected. As will be appreciated, the second electronic device 200-2 and the media presentation system 500 may thus be associated with IP addresses within the same sub network. The second electronic device 200-2 may hence provide a user interface that allows a user 600 (FIGS. 1B, 3B) to select media content for presentation by the electronic device 200-2 itself and, also, to generate media control request(s) to cause the media content to be presented, or played, by the media presentation system 500. Furthermore, the server media request and the local media request are both configured to cause a media control operation, performed at the second electronic device 200-2, to be implemented at the media presentation system 500.

Reference is now made to FIG. 1B, which schematically illustrates an example scenario where embodiments of the present disclosure may be applied. As is illustrated, two persons 600-1 and 600-2 may stand and talk to each other. In an example scenario related to a social gathering, a host (i.e., the user 600-2 in this example) may for example interact with his second electronic device 200-2 to remotely control the playback of media content at the media presentation system 500 at the social gathering, e.g. the playback of streamed music through loudspeakers(s) 500-1 (see FIG. 1A). This way, it is for example possible for the host (i.e., user 600-2 in this example) to control the playback of music that is to be played at the social gathering.

While the above example is described with respect to the second electronic device 200-2, it should be appreciated that the first electronic device 200-1 may have the same features and, thus, employ the same functionality as the second electronic device 200-2. For example, the first electronic device 200-1 may also implement, or otherwise utilize, any of the techniques described in WO2014/001913A2.

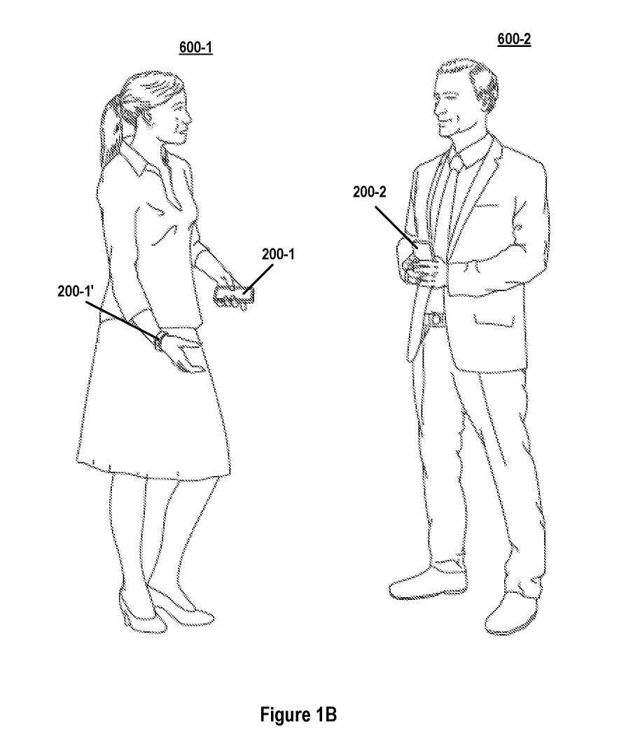

Turning now to FIG. 2, an example environment where some embodiments of this disclosure may be applied will be described. An electronic device 200 (e.g., the second electronic device 200-2 of FIGS. 1A-1B) may be communicatively connectable to the server 300 via the network 400, e.g. the Internet, as described above. As can be seen in FIG. 2, only a single electronic device 200-2 and a single server 300 are shown. However, the server 300 may support the simultaneous use of multiple electronic devices 200-1, 200-2, etc., and/or the second electronic device 200-2 can simultaneously access media content at multiple servers 300. Although FIG. 2 illustrates the server 300 in accordance with some embodiments, FIG. 2 is intended more as a functional description of the various features, or components, which may be present in one or more servers, rather than a structural schematic of the various implementations described throughout this disclosure. In practice, and as recognized by persons skilled in the art, components shown separately could be combined and some components could be separated.

In the following description and in order not to obscure the detailed description with unnecessary detail, the media content will in general be exemplified to be audio content, e.g. in form of music. This should, however, not be interpreted as limiting the scope of the various embodiments of the disclosed embodiments.

As is schematically shown in FIG. 2, the electronic device 200 (e.g., the second electronic device 200-2 shown in FIG. 1) may be used for the playback of media content (e.g., audio content such as music), which is provided by the server 300. The electronic device 200 may include one or several physical computer resources, or hardware resources 210. The hardware resources 210 may e.g. include one or several processors (or, processing circuitry), a communications interface (or, communication circuitry) and one or several memories. Likewise, the server 300 operating as a media server may include one or several physical computer resources, or hardware resources 316. The hardware resources 316 may likewise include e.g. include one or several processors (or, processing circuitry), a communications interface (or, communication circuitry) and one or several memories.

The server 300 may include an operating system or other processing system which supports execution of a software application 310, including a media server application 312 which may be used, for example, to stream media content such as audio content (e.g., music). The software application 310 corresponds to instructions stored in the memory of the server 300 (e.g., in a non-transitory computer-readable storage medium) and configured for execution by the one or several processors of the server 300. A media stream service 320 may be used to buffer media content, for streaming to one or more media streams 322, 324, and 326. A media application interface 314 may receive requests from electronic devices 200 or other systems, to retrieve media content 331 from the server 300.

Media content 331, or media items, may be provided, for example, within a first storage such as a memory (e.g., including a database), or may be received by the server 300 from another source (not shown). The other source (not shown) could be external to the server 300, i.e. it may be located remotely from the server 300.

A media streaming logic 330 may be used to retrieve or otherwise access the media content 331 in response to requests from electronic devices 200 or other systems, and populate the media stream service 320 with streams 322, 324, 326 of corresponding media content data 323, 325, 327 that may be returned, i.e. streamed, to the requesting electronic device 200.

The electronic device 200 comprises a user interface 230. The user interface 230 may, among other things, be adapted to display or otherwise provide a visual array of media options 232 and to determine user input. The visual array of media options 232 may for example be provided as a two-dimensional grid, a list, or other visual array format. Each media option in the visual array of media options 232 may correspond to a respective media stream 322, 324, 326.

Selecting a particular media option within the visual array 232 may be used, or otherwise interpreted, as a request or instruction to the media server application 312 to stream or otherwise return a corresponding particular media content item. For example, in accordance with some embodiments, the software application 310 at the server 300 may be used to stream or otherwise communicate media content to the electronic device 200, wherein the user interface 230 at the electronic device 200 is adapted to display a plurality of media options that correspond to respective media streams.

In accordance with some embodiments, the electronic device 200 may also include a media playback application 220, which includes a playback logic 222, pre-buffering logic 145, and a volume function 146, which may be used to control the playback of media content that is received from the media server application 312, for playback by the electronic device 200, as described in further detail below. The media playback application 220 corresponds to instructions stored in the memory of the electronic device 200 (e.g., in a non-transitory computer-readable storage medium) and configured for execution by the one or several processors of the electronic device 200.

A user 600 (e.g., the user 600-2 of FIG. 1B) may interact 11 with the user interface 230 of the electronic device 200 and issue requests, for example the playing of a selected media option at the electronic device 200. The user's selection of a particular media option may be communicated 12 to the media server application 312, via the media application interface 314. The media server application 312 may then be instructed 13 to stream corresponding media content, including one or more streams of media content data 323, 325, 327, and subsequently stream 14 or otherwise communicate the media content data, e.g., selected media, to the user's electronic device 200. In accordance with some embodiments, pre-buffering requests from the electronic device 200 may also be communicated 12 to the media server application 312 via the media application interface 314. At the electronic device 200, in response to the user's interaction with the user interface 230, the media playback application 220, including the playback logic 222, may play 10 the requested media content to the user 600.

Reference is now made to FIG. 3A and 3B. FIG. 3A is a signaling diagram of example communications between a wearable device 200-1′, a first electronic device 200-1, a second electronic device 200-2, a server 300 and a media presentation system 500 (e.g., loudspeaker(s) 500-1, FIG. 1A) shown in FIG. 3B. FIG. 3B exemplifies a scenario at a social gathering (e.g., a party) where embodiments of the present disclosure may be advantageously applied.

In this example scenario, a second user 600-2 may be hosting the social gathering. The second user 600-2 may have a second electronic device 200-2, which is associated with this second user 600-2. For example, the second electronic device 200-2 may be associated with the second user 600-2 through a Subscriber Identification Module (SIM) or similar. Several other persons may also be present at the social gathering. In FIG. 3B, only one of these persons is schematically illustrated, i.e. the first user 600-1. The first user 600-1 may have a first electronic device 200-1, which is associated with the first user 600-1. Similar to the above, the first electronic device 200-1 may be associated with the first user 600-1 through a Subscriber Identification Module (SIM) or similar.

In the example scenario of FIG. 3B, the first user 600-1 also wears a wearable device 200-1′, here exemplified by a computerized wristwatch or wristwatch-like device, sometimes referred to as a smart watch. A smart watch is a computerized wearable device 200-1′ with functionality that is typically enhanced beyond timekeeping. While early models of smart watches can perform basic tasks, such as calculations, translations, and game-playing, modem smart watches are effectively wearable computer devices. Many smart watches run applications (a.k.a. apps), while a smaller number of models run a mobile operating system and function as portable media players, offering playback of FM radio, audio, and video files to the user e.g. via a Bluetooth headset. Some smart watch models, also called ‘watch phones’, may feature full mobile phone capability, and can make or answer phone calls. Most wearable devices 200-1′ have a rechargeable battery and graphical display and many have a touch screen. Like other computers, a wearable device 200-1′ may collect information from internal and/or external sensors. It may also control, and/or retrieve data from, other devices such as the first electronic device 200-1. The wearable device 200-1′ may e.g. support wireless technologies like Bluetooth, Wi-Fi, and GPS, etc.

As can be seen in FIG. 3A, the wearable device 200-1′ may communicatively connect 1010 to the first electronic device 200-1. For example, the wearable device 200-1′ may communicatively connect 1010 to the first electronic device 200-1 to access one or more functionalities that are hosted by the first electronic device 200-1. This may, for example, be achieved utilizing a wireless short-range technology (e.g., a wireless PAN protocol, such as Bluetooth). In other words, the wearable device 200-1′ may be paired 1010 to the first electronic device 200-1 to access the one or more functionalities of the first electronic device 200-1.

As will be appreciated from the following description, the wearable device 200-1′ may be operated by the user 600-1 to remotely control the manipulation of a playlist hosted by a nearby second electronic device 200-2 (see also FIG. 3B).

In some embodiments, the wearable device 200-1′ is configured to transmit 1020 a signal to the first electronic device 200-1 to which the wearable device 200-1′ is associated (i.e., paired). This signal may be indicative of the wearable device 200-1′ requesting authorization to control the manipulation of the playlist hosted by the second electronic device 200-2. In response to receiving 1020 this signal, the first electronic device 200-1 may indicate 1030 to the second electronic device 200-2 that the first electronic device 200-1 requests authorization to control the manipulation of the playlist hosted by the second electronic device 200-2. This action, or step, 1030 may include communicatively connecting the first electronic device 200-1 with the second electronic device 200-1 e.g. using a wireless short-range technology. In some embodiments, this action, or step, 1030 may optionally also include sending an explicit request signal to the first electronic device 200-1, the explicit request signal being indicative of the first electronic device 200-1 (and its associated wearable device 200-1′) requesting authorization to control the manipulation of the playlist hosted by the second electronic device 200-2. In alternative embodiments, it is not necessary to transmit any explicit request signal. Rather, the mere fact that the first and second electronic devices 200-1 and 200-2 are communicatively connected (i.e., paired) may be interpreted by the second electronic device 200-2 to be an indication that the first electronic device 200-1 requests authorization to control the manipulation of the playlist hosted by the second electronic device 200-2.

The second electronic device 200-2 may be configured to access 1040 geographic information that is indicative of a geographic location of the first electronic device 200-1 (and, in some embodiments, of its own location). In some embodiments, accessing 1040 the geographic information that is indicative of the geographic location of the first electronic device comprises sensing that the first electronic device 200-1 is located within the defined geographic proximity. For example, sensing that the first electronic device 200-1 is located within the defined geographic proximity may comprise utilizing wireless communication technology (e.g., Bluetooth/PAN proximity sensing technology and/or Wi-Fi/WLAN proximity sensing technology). As will be appreciated, the geographic location of the first electronic device 200-1 is typically also a suitable indication of the geographic location of the wearable device 200-1′. Based on the accessed 1040 geographic information of the first electronic device 200-1, the second electronic device 200-2 is capable of determining 1050, or otherwise concluding, whether the first and second electronic devices 200-1, 200-2 are located within a defined geographic proximity. That is, the second electronic device 200-2 may be configured to determine 1050 whether the first and second electronic devices 200-1, 200-2 are proximate to each other. In response to a determination 1050 that the first and second electronic devices 200-1, 200-2 are located within the defined geographic proximity (i.e., the first and second electronic devices 200-1, 200-2 are proximate to each other), the second electronic device 200-2 authorizes the first electronic device 200-1 to manipulate the playlist.

In some embodiments, a user 600-2 may optionally operate the user interface of the second electronic device 200-2 to approve or reject a request to authorize the first electronic device 200-1 to manipulate the playlist hosted by the second electronic device 200-2.

For example, in response to detecting 1060 a first control gesture (which may e.g. be a tap gesture, a swipe gesture, or a hovering gesture) at the user interface of the second electronic device 200-2, the second electronic device 200-2 interprets this first control gesture to be an instruction to approve the request of the authorization to control the manipulation of the playlist. In response thereto, the second electronic device 200-2 authorizes the first electronic device 200-1 to manipulate the playlist hosted by the second electronic device 200-2. Optionally, the second electronic device 200-2 may also transmit 1070 an acknowledgement (ACK) signal to the first electronic device 200-1. The first electronic device 200-1 may thus be informed that the second electronic device 200-2 has authorized the first electronic device 200-1 to manipulate the playlist hosted by the second electronic device 200-2. The first electronic device 200-1 may optionally also forward, i.e. transmit 1080, an ACK signal to the wearable device 200-1′.

Otherwise, in response to detecting a different, i.e. second, control gesture (which may e.g. be a tap gesture, a swipe gesture, or a hovering gesture) at the user interface of the second electronic device 200-2, the second electronic device 200-2 interprets this second control gesture to be an instruction to disapprove (i.e., reject) the request of the authorization to control the manipulation of the playlist hosted by the second electronic device 200-2. In response thereto, the second electronic device 200-2 rejects the request and prevents the first electronic device from manipulating the playlist hosted by the second electronic device 200-2. Optionally, the second electronic device 200-2 may also transmit (not shown in FIG. 3A) a negative acknowledgement (NACK) signal to the first electronic device 200-1. The first electronic device 200-1 may thus be informed that the second electronic device 200-2 has rejected the request and prevented the first electronic device 200-1 from manipulating the playlist hosted by the second electronic device 200-2. The first electronic device 200-1 may optionally also forward, i.e. transmit, a NACK signal, to the wearable device 200-1′.

In some embodiments, once the second electronic device 200-2 has authorized the first electronic device 200-1 to manipulate the playlist hosted by the second electronic device 200-2, users 600-1, 600-2 of both the first and second electronic devices 200-1, 200-2 may operate the user interfaces of the respective electronic devices 200-1, 200-2 to update 1090 the playlist that is hosted by the second electronic device 200-2, e.g. the order in which the media items of the playlist are to be played next. For example, the second electronic device 200-2 generates 1090 an updated order of media items in the playlist hosted by the second electronic in response to receiving a request from either the first electronic device 200-1 or the second electronic device 200-2 to manipulate the playlist. As will be appreciated, a user 600-1 may also operate the user interface of the wearable device 200-1′, which is communicatively connected (e.g., paired) with the first electronic device 200-1, in order to update 1090 the playlist hosted by the second electronic device 200-2. This way, it is made possible to enable a user 600-2 of a wearable device, e.g. a computerized wristwatch, to remotely control 1090 a queue of playable media items (e.g., songs) of a playlist, which is associated with a different, i.e. a second, electronic device 200-2. The authorization to control the playlist using the wearable device 200-1′ is determined based on the proximity between the second electronic device 200-2 and the first electronic device 200-1 to which the wearable device 200-1′ is associated (e.g., paired via wireless short-range communication). This allows the user 600-1 of the wearable device 200-1′ to control another user's playlist when these users (and their respective electronic devices) are proximate to one another.

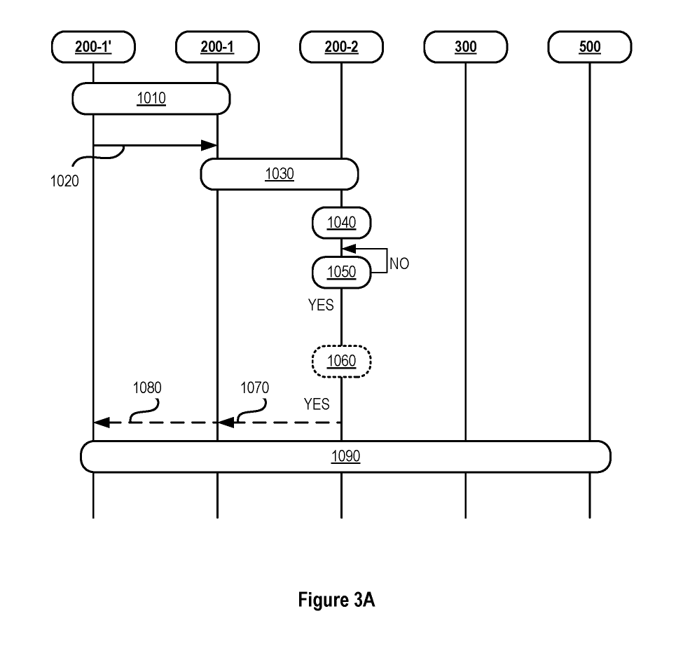

Reference is now made to FIG. 4, which schematically illustrates a flowchart of a method 2000 for controlling the manipulation of a playlist hosted by a second electronic device 200-2 in accordance with some embodiments. The playlist may for example include a queue of media items (e.g., songs) to be played. The method may be performed by, or otherwise executed in, the second electronic device 200-2 (see FIGS. 1-3). The second electronic device 200-2 typically comprises one or more processors and one or more memories storing instructions for execution by the processor(s). These instructions include instructions for performing the method 2000. The second electronic device 200-2 may also comprise a communications interface. Additionally, the second electronic device 200-2 may comprise a user interface (UI).

Geographic information that is indicative of a geographic location of a first electronic device 200-1 is accessed 2040. For example, accessing this geographic information may comprise sensing that the first electronic device 200-1 is located within a defined geographic proximity. In some embodiments, sensing that the first electronic device 200-1 is located within the defined geographic proximity comprises utilizing a wireless short-range communication technology. In some embodiments, sensing that the first electronic device 200-1 is located within the defined geographic proximity comprises using Bluetooth proximity sensing technology. Additionally, or alternatively, sensing that the first electronic device 200-1 is located within the defined geographic proximity may comprise using Wi-Fi proximity sensing technology.

Based on the accessed geographic information, it may be determined 2050 whether the first and second electronic devices 200-1, 200-2 are located within the defined geographic proximity. In response to a determination 2050-Yes that the first and second electronic devices are located within the defined geographic proximity, the first electronic device is authorized 2060 to manipulate the playlist. In some embodiments, this action (or, step) may further comprise: in response to detecting a first control gesture (e.g., a tap gesture, a swipe gesture, or a hovering gesture) at a user interface of the second electronic device, interpreting the first control gesture to be an instruction to approve the request of the authorization to control the manipulation of the playlist, and in response thereto authorizing the first electronic device to manipulate the playlist. Alternatively, in response to detecting a second control gesture (e.g., a tap gesture, a swipe gesture, or a hovering gesture) at the user interface, the second control gesture is interpreted to be an instruction to disapprove the request of the authorization to control the manipulation of the playlist. In response thereto, the request is rejected and the first electronic device 200-1 is prevented from manipulating the playlist.

Furthermore, the method may additionally comprise generating 2090 an updated order of media items in the playlist in response to receiving a request from either the first electronic device 200-1 (or a wearable device 200-1′ associated with the first electronic device 200-1, wherein the first electronic device relays the request from the wearable device 200-1′ to the second electronic device 200-2) or the second electronic device 200-2 to manipulate the playlist. In some embodiments, the order of media items is updated repeatedly in response to requests from both the first electronic device 200-1 (or its associated wearable device 200-1′) and the second electronic device 200-2. For example, an updated order is generated in response to a request from the first electronic device 200-1 (or its associated wearable device 200-1′), and another updated order is then generated in response to a request from the second electronic device 200-2 (or vice-versa).

In some embodiments, the method may optionally also comprise (prior to authorizing the second electronic device to manipulate the playlist) receiving 2042, from the first electronic device 200-1, a signal being indicative of the first electronic device 200-1 requesting authorization to control the manipulation of the playlist.

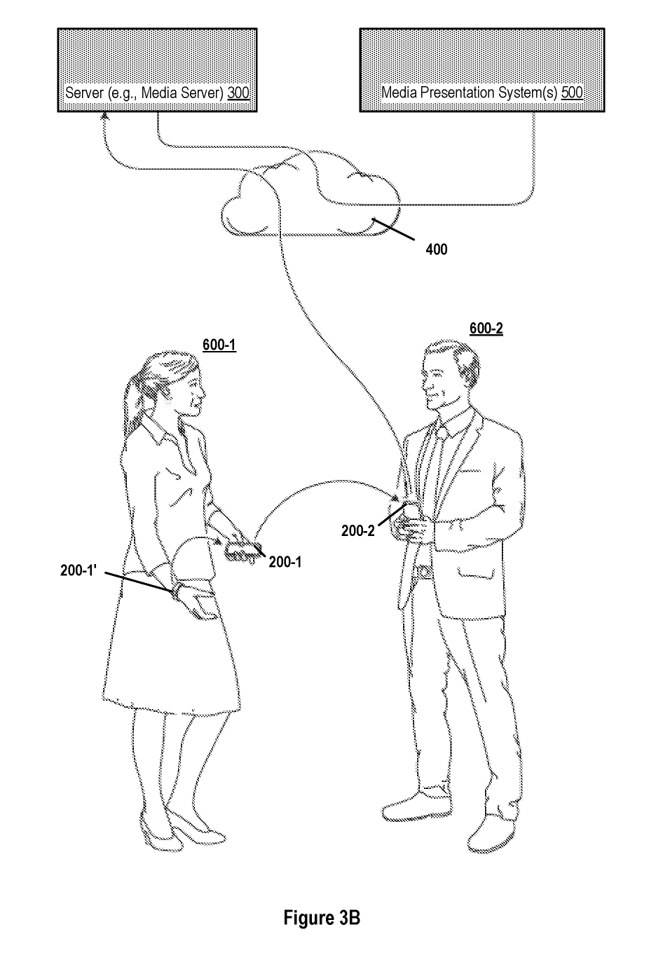

Reference is now made to FIG. 5, which schematically illustrates a flowchart of a method 3000 for remotely controlling the manipulation of a playlist hosted by a second electronic device 200-2 in accordance with some embodiments. The method is performed by a wearable device 200-1′ which is associated with a first electronic device 201-1. For example, the wearable device 200-1′ is communicatively connected to the first electronic device 200-1 to access one or more functionalities hosted by the first electronic device 201-1. In some implementations, the wearable device 200-1′ is communicatively connected to the first electronic device using wireless short-range communication technology, such as Bluetooth. The wearable device 200-1′ may be computerized. To this end, the wearable device 200-1′ may comprise a processor and a memory storing instructions for execution by the processor. These instructions include instructions for performing the method 3000.

The wearable device 200-1′ may e.g. be a computerized wristwatch or wristwatch-like device.

The method 3000 may comprise sending 3020, i.e. transmitting, a signal to the first electronic device 200-1, wherein the signal being is indicative of the wearable device 200-1 requesting authorization to control the manipulation of the playlist hosted by the second electronic device 200-2.

In some embodiments, the method may optionally also comprise receiving an ACK signal from either or both of the first and second electronic devices 200-1, 200-2 (e.g., from the second electronic device 200-2 via the first electronic device 200-1). The ACK signal is indicative of the second electronic device 200-2 having approved the request for authorization to control the manipulation of the playlist hosted by the second electronic device 200-2. Alternatively, the method may optionally also comprise receiving a NACK signal from either or both of the first and second electronic devices 200-1, 200-2 (e.g., from the second electronic device 200-2 via the first electronic device 200-1). The NACK signal is indicative of the second electronic device 200-2 having disapproved the request for authorization to control the manipulation of the playlist hosted by the second electronic device 200-2.

Once the second electronic device 200-2 has approved the first electronic device 200-1 and/or the wearable device 200-1′ associated therewith to control the playlist hosted by the second electronic device 200-2, the UI 260 of the wearable device 200-1′ may be enabled 3080 to present the playlist hosted by the second electronic device 200-2 at the UI 260 of the wearable device 200-1′ for subsequent manipulation by the user 600-1 of the wearable device 200-1′.

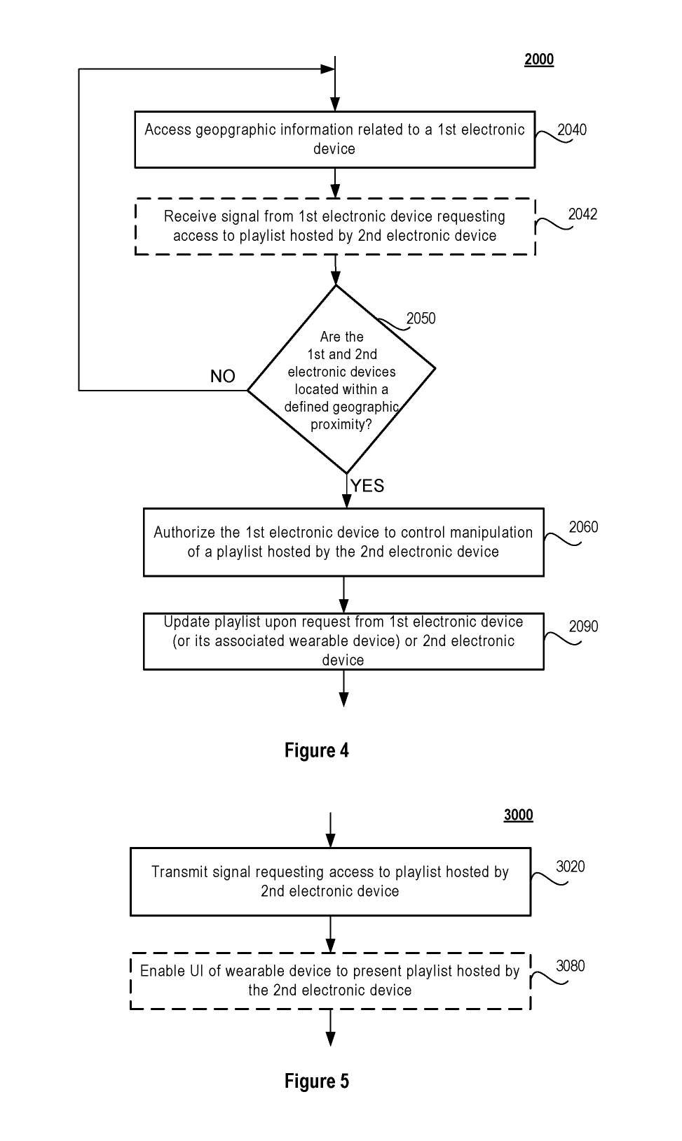

FIGS. 6A-C schematically illustrate an example UI 260 of a wearable device 200-1′, e.g. a computerized wristwatch or wristwatch-like device. The UI includes output device(s) and input device(s). In some implementations, the UI includes a display that includes a touch-sensitive surface, in which case the display is a touch-sensitive display. The touch-sensitive display is adapted to detect or otherwise determine a user input.

With reference to FIGS. 6A-6C, an example embodiment of a method of operating the wearable device 200-1′ for manipulation of a playlist hosted by a nearby second electronic device 200-2 will be described in further detail. A user 600-1 may optionally be presented with textual information 6010, 6020, 6030 that presents selectable user preference options to the user 600-1 of the wearable device 200-1′. As will be recognized, the method may include receiving a request to access a playlist hosted by the second electronic device 200-2. Receiving this request may include detecting a first control gesture. In this example, the first control gesture is a tap gesture 12 within the display area corresponding to the user preference selection option 6030 (i.e., ‘Party’). Upon detecting this tap gesture within the display area corresponding to the user preference selection option 6030, this is interpreted by the wearable device 200-1′ to be an instruction to send a signal to the first electronic device 200-1, wherein the signal is indicative of the wearable device 200-1′ requesting authorization to control the manipulation of the playlist hosted by the second electronic device 200-2, and thus to manipulate the playlist.

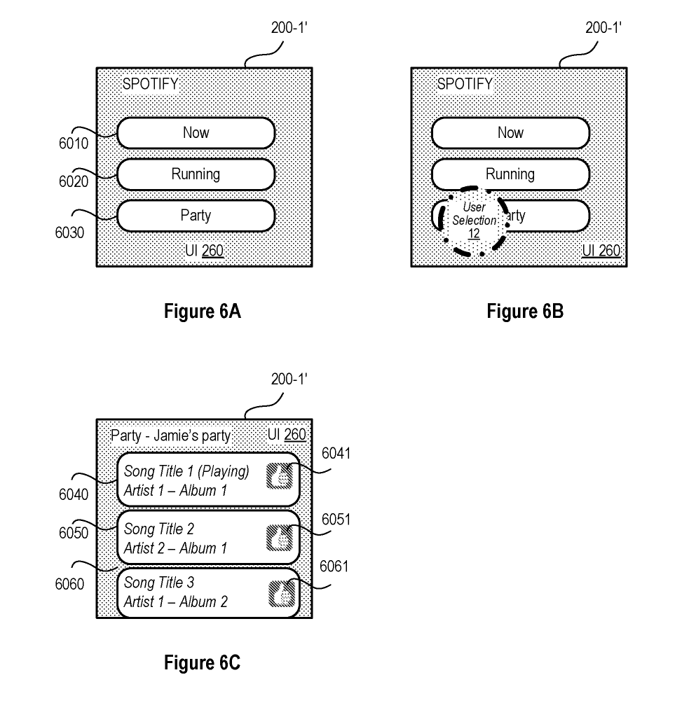

Turning now to FIG. 7, the second electronic device 200-2 may be configured to access geographic information that is indicative of a geographic location of the first electronic device 200-1 to which the wearable device 200-1′ of FIGS. 6A-6C is associated (e.g., paired using Bluetooth). Based on the geographic information, the second electronic device 200-2 may be configured to determine whether the first and second electronic devices 200-1 and 200-2 are located within a defined geographic proximity. In response to a determination that the first and second electronic devices 200-1, 200-2 are located within the defined geographic proximity, the second electronic device 200-2 may be configured to authorize the first electronic device 200-1 (and its associated (e.g., paired) wearable device 200-1′) to manipulate playlist(s) hosted by the second electronic device 200-2.

FIG. 7 schematically illustrates an example UI 230 of the second electronic device 200-2, e.g. a smart phone. The UI 230 includes output device(s) and input device(s). In some implementations, the UI includes a display that includes a touch-sensitive surface, in which case the display is a touch-sensitive display. The touch-sensitive display is adapted to detect or otherwise determine a user input. Also, FIG. 7 schematically illustrates an example UI of an optional wearable device 200-2′, e.g. a computerized wristwatch or wristwatch-like device, associated (e.g., paired) with the second electronic device 200-2. The UI includes output device(s) and input device(s), as is known and conventional in the art. In some implementations, the UI includes a display that includes a touch-sensitive surface, in which case the display is a touch-sensitive display. The touch-sensitive display is adapted to detect or otherwise determine a user input.

In the example shown in FIG. 7, a user 600-2 of the second electronic device may operate a UI 230 of the second electronic device 200-2 to authorize (or reject) requests for accessing the playlist(s) hosted by the second electronic device 200-2. For example, in response to detecting a first control gesture at the UI 230 of the second electronic device 200-2, the second electronic device 200-2 interprets this first control gesture to be an instruction to approve the request of the authorization to control the manipulation of the playlist, and in response thereto authorizes the first electronic device 200-1 (and/or its associated wearable device 200-1′) to access and hence manipulate the playlist(s) hosted by the second electronic device 200-2. For example, the first control gesture is a tap gesture within the display area corresponding to the user preference selection option 7010 (i.e., ‘Allow’). Upon detecting this tap gesture within the display area corresponding to the user preference selection option 7010, this is interpreted by the second electronic device 200-2 to be an approval of a request to access the playlist(s) hosted by the second electronic device 200-2. Alternatively, in response to detecting a second control gesture at the UI 230 of the second electronic device 200-2, the second electronic device 200-2 interprets this first control gesture to be an instruction to reject the request for the authorization to control the manipulation of the playlist(s) hosted by the second electronic device 200-2, and in response thereto rejects the request and prevents the first electronic device 200-1 (and/or its associated wearable device 200-1′) from accessing and hence manipulating the playlist(s) hosted by the second electronic device 200-2. For example, the second control gesture is a tap gesture within the display area corresponding to the user preference selection option 7020 (i.e., ‘Deny’). Upon detecting this tap gesture within the display area corresponding to the user preference selection option 7020, this is interpreted by the second electronic device 200-2 to be a rejection of a request to access the playlist(s) hosted by the second electronic device 200-2.

The UI 230 may be used to allow or deny multiple requests for authorization to control manipulation of the playlist(s) hosted by the second electronic device 200-2. The multiple requests may be transmitted to the second electronic device 200-2 from the same electronic device 200 (e.g., first electronic device 200-1, which forwards requests from its associated wearable device 200-1′) and/or different electronic devices 200 (e.g., which forward requests from respective associated wearable devices). In one example, a request from the first electronic device 200-1 is allowed and a request from a third electronic device 200 is denied. In another example, a first request from the first electronic device 200-1 is denied and a second request from the first electronic device 200-1 is allowed (or vice-versa).

Furthermore, the UI 230 may optionally also include a user preference selection option 7030 ‘Dismiss’ such that a user 600-2 operating the UI 230 may select to dismiss the request for access to the playlist(s) hosted by the second electronic device 200-2 (e.g., and thus close the UI 230 without responding to the request).

As will be appreciated, a user 600-2 may operate the UI 260 of the optional wearable device 200-2′ in a similar manner e.g. by performing a tap gesture in any of display areas corresponding to user preference selection options 7040, 7050, and 7060, respectively. To this end, the wearable device 200-2′ may be communicatively connected to the second electronic device 200-2 to access one or more of the functionalities of the second electronic device 200-2. This may be achieved utilizing a wireless short-range technology such as Bluetooth. In other words, the wearable device 200-2′ may be paired to the second electronic device 200-2 to access the one or more functionalities of the second electronic device 200-2.

With continued reference to FIG. 6C, upon an authorization by the second electronic device 200-2 to allow access to the playlist(s) hosted by the second electronic device 200-2, the UI of the wearable device 200-1′ can be enabled to present the playlist(s), here exemplified by media items 6040, 6050, and 6060, respectively, hosted by the second electronic device 200-2, for subsequent manipulation by a user 600-1 that operates the UI of the wearable device 200-1′.

In some embodiments, manipulation of the playlist(s) hosted by the second electronic device 200-2 is implemented through voting. To this end, the UI of the wearable device 200-1′ may comprise voting buttons 6041, 6051, and 6061, respectively. Each voting button 6041, 6051, and 6061 may be associated with a particular one of the media items 6040, 6050, 6060 (e.g., songs) in the list of media items of the playlist shown in FIG. 6C. For example, upon the user 600-1 performing a tap gesture within an area corresponding to voting button 6051, this will be interpreted by the wearable device 200-1′ to mean that the user likes, or votes for, the media item 6050 associated with the voting button 6051. All likes, or votes, made by the user 601 may be reported (i.e., signaled) to the second electronic device 200-2 that hosts the playlist(s). On the basis of the total number of likes, or votes, the second electronic device 200-2 changes (i.e., updates) the order of media items of the playlist(s). For example, when the total number of votes, or likes, for a certain media item exceeds the total number of votes, or likes, of a preceding media item, the second electronic device 200-2 changes the order between (e.g., swaps the positions of) these media items. In some implementations, voting is paused while a currently played media item (e.g., a song) is fading out, for example during a final portion of a specified duration (e.g., the last 2, 5 or 10 second) of a currently played media item. This may allow for a more stabilized voting procedure, especially if the voting is performed by several users simultaneously or essentially simultaneously.

In some embodiments, a user 600-1 operating the wearable device 200-1′ may additionally, or alternatively, be allowed to operate the UI of the wearable device 200-1′ to add media items to the playlist(s) hosted by the second electronic device 200-2. This may enhance the user experience even further as it allows the user 600-1 to influence the media items in the playlist(s) by suggesting media items of his or her own choice.

In some embodiments, the manipulation of the playlist(s) hosted by the second electronic device 200-2 is implemented through voting only. That is, any change or update of the order of media items in the playlist(s) is exclusively made in accordance with the voting. In other words, no other means for manipulating the playlist(s) hosted by the second electronic device 200-2 may be allowed. This allows for a very user-friendly and intuitive user experience when sharing media presentations (e.g., the playback of music at a social gathering such as a party).

For example, if several (i.e., two or more) electronic devices and/or wearable devices have been authorized to manipulate the playlist(s) hosted by the second electronic device 200-2, several users may use their respective electronic devices and/or wearable devices to collaboratively influence the order in which media items of a common playlist (i.e., the playlist hosted by the second electronic device 200-2 in this example) are played. For example, a group of people that is located with a defined geographic proximity may collaboratively control the queue of playable media items to be played at a social gathering. This may lead to improved user experiences at social gatherings such as parties.

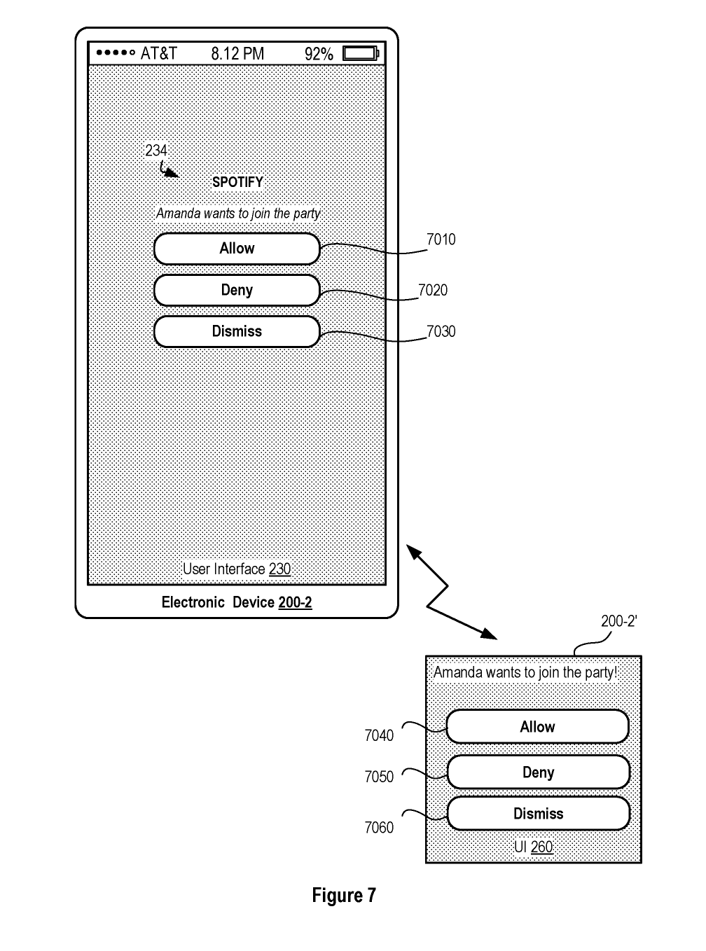

Reference is now made to FIG. 8 which schematically illustrates an example implementation of a second electronic device 200-2. The second electronic device may for instance be a mobile phone, a smart phone, a tablet computer, a media player, or a desktop computer. The second electronic device 200-2 may be configured to perform, or otherwise execute, the methods in accordance with any of the embodiments described herein in conjunction with FIGS. 2, 3A, and 4. To this end, the second electronic device 200-2 comprises a user interface 230. The second electronic device 200-2 also comprises hardware resources 210 (see also FIG. 2). For example, the second electronic device 200-2 may comprise one or more processors 210A and one or more memories 210B. Also, a communications interface 210C, or a communications circuitry, may be provided in order to allow the second electronic device 200-2 to communicate with other electronic devices 200, servers 300, and/or media presentation systems 500 (e.g. via a network 400 such as the Internet, FIG. 1). To this end, the communications interface 210C may comprise a transmitter (Tx) and a receiver (Rx). Alternatively, the communications interface 210C may comprise a transceiver (Tx/Rx) combining both transmission and reception capabilities. The communications interface 210C may include a radio frequency (RF) interface allowing the second electronic device 200-2 to communicate with electronic devices 200-1 and/or servers 300 and/or media presentation systems 500 through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth, etc. As can be seen in FIG. 2, the second electronic device 200-2 may also comprise one or more applications, e.g. the media playback software application 220. The applications are sets of instructions (e.g., computer program code), stored in the one or more memories 210B (e.g., in a non-transitory computer-readable storage medium), that when executed by the one or more processors 210A control the operation of the second electronic device 200-2.

In some implementations, the one or more memories 210B store computer program code, which, when run by the one or more processors 210A causes the second electronic device 200-2 to access geographic information that is indicative of a geographic location of a first electronic device; determine, based on the geographic information, whether the first and second electronic devices are located within a defined geographic proximity; and in response to a determination that the first and second electronic devices are located within the defined geographic proximity, authorize the first electronic device to manipulate the playlist.

In some implementations, the one or more memories 210B store computer program code, which, when run by the one or more processors 210A causes the second electronic device 200-2 to sense (e.g., through the communications interface 210C) that the first electronic device is located within the defined geographic proximity. For example, sensing that the first electronic device is located within the defined geographic proximity may include utilizing a wireless communication technology (e.g., employing Bluetooth proximity sensing technology and/or employing Wi-Fi proximity sensing technology).

In some implementations, the one or more memories 210B store computer program code, which, when run by the one or more processors 210A causes the second electronic device 200-2 to generate an updated order of media items in the playlist in response to receiving a request from either the first electronic device or the second electronic device to manipulate the playlist.

In some implementations, the communications interface 210C is configured to receive, from a first electronic device 200-1, a signal that is indicative of the first electronic device (and/or its associated wearable device 200-1) requesting authorization to control the manipulation of the playlist(s) hosted by the second electronic device 200-2.

In some implementations, the one or more memories 210B store computer program code, which, when run by the one or more processors 210A causes the second electronic device 200-2 to interpret a first control gesture to be an instruction to approve the request for authorization to control the manipulation of the playlist(s) hosted by the second electronic device 200-2 in response to detecting the first control gesture (e.g., a tap gesture, a swipe gesture, or a hovering gesture) at the UI 230 of the second electronic device 200-2, and, in response thereto, authorize the first electronic device 200-1 to manipulate the playlist(s) hosted by the second electronic device 200-2.

In some implementations, the one or more memories 210B store computer program code, which, when run by the one or more processors 210A causes the second electronic device 200-2 to interpret a second control gesture to be an instruction to reject the request for authorization to control the manipulation of the playlist(s) hosted by the second electronic device 200-2 in response to detecting the second control gesture (e.g., a tap gesture, a swipe gesture, or a hovering gesture) at the UI 230 of the second electronic device 200-2, and, in response thereto, reject the request and prevent the first electronic device 200-1 from manipulating the playlist(s) hosted by the second electronic device 200-2.

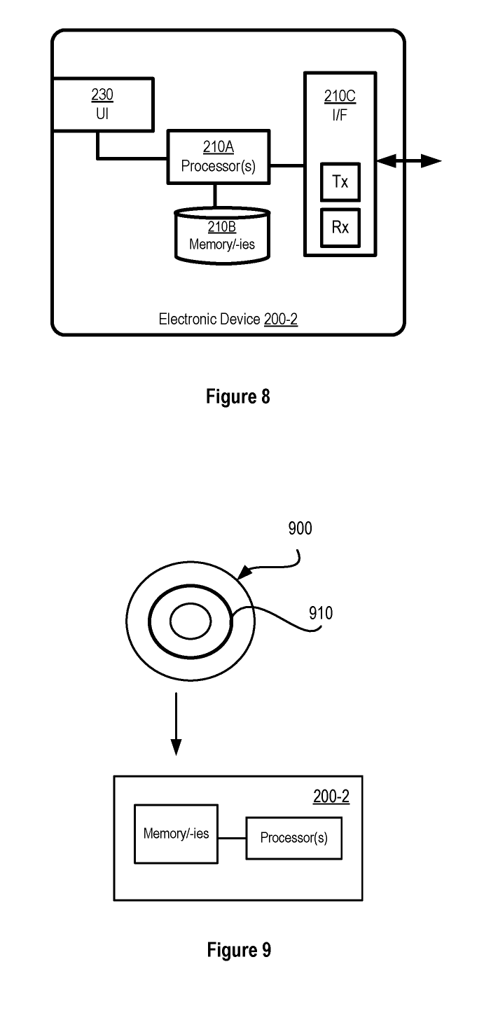

FIG. 9 shows an example of a non-transitory computer-readable storage medium, in this example in the form of a data disc 900. In some embodiments the data disc 900 is a magnetic data storage disc. The data disc 900 is configured to carry instructions 910 that can be loaded into a memory 210B of an electronic device 200, e.g. the second electronic device 200-2. Upon execution of the instructions by a processor 210A of the electronic device 200, the electronic device 200 is caused to execute a method or procedure according to any of the embodiments described herein in conjunction with FIGS. 2 and 4. The data disc 900 is arranged to be connected to or within and read by a reading device (not shown), for loading the instructions into the memory 210B. One such example of a reading device in combination with one (or several) data disc(s) 900 is a hard drive. It should be noted that the computer-readable medium can also be other mediums such as compact discs, flash memories or other memory technologies. In such embodiments the data disc 900 is one type of a tangible computer-readable medium. The instructions may alternatively be downloaded to a computer data reading device, such as an electronic device 200 capable of reading computer coded data on a computer-readable medium, by modulating the instructions into a computer-readable signal (not shown) which is transmitted via a wireless (or wired) interface (for example via the Internet) to the computer data reading device for loading the instructions into a processor 210A of the electronic device 200. In such embodiments, the computer-readable signal is one type of a non-tangible computer-readable medium.

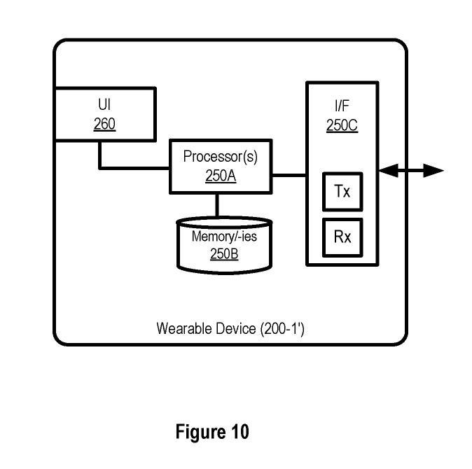

Reference is now made to FIG. 10 which schematically illustrates a wearable device 200-1′ (e.g., a computerized wristwatch or wristwatch-like device) in accordance with some embodiments. The wearable device 200-1′ may be configured to perform, or otherwise execute, the methods in accordance with any one of the embodiments described herein in conjunction with FIGS. 2, 3A, and 5. To this end, the wearable device 200-1′ comprises a user interface 260. The wearable device 200-1′ also comprises hardware resources 250. For example, the wearable device 200-1′ may comprise one or more processors 250A and one or more memories 250B. Also, a communications interface 250C, or a communications circuitry, may be provided in order to allow wearable device 200-1′ to communicate with an electronic device such as the first electronic device 200-1. To this end, the communications interface 250C may comprise a transmitter (Tx) and a receiver (Rx). Alternatively, the communications interface 250C may comprise a transceiver (Tx/Rx) combining both transmission and reception capabilities. The communications interface 250C may include a radio frequency (RF) interface allowing the wearable device 200-1′ to communicate with electronic device 200-1 and/or other devices through a radio frequency band through the use of different radio frequency technologies such as LTE (Long Term Evolution), WCDMA (Wideband Code Division Multiple Access), any other cellular network standardized by the 3rd Generation Partnership Project (3GPP), or any other wireless technology such as Wi-Fi, Bluetooth, etc.

The wearable device 200-1′ may also comprise one or more applications (e.g., media playback software). The applications are sets of instructions, stored in the one or more memories 250B (e.g., in a non-transitory computer-readable storage medium), that when executed by the one or more processors 250A control the operation of the wearable device 200-1′.

In some implementations, the one or more memories 250B store computer program code, which, when run by the one or more processors 250A causes the wearable device 200-1′ to send, through the communications interface 250C, a signal to a first electronic device 200-1 to which the wearable device 200-1′ is communicatively connected (e.g., paired via Bluetooth). This signal is indicative of the wearable device 200-1′ requesting authorization to control the manipulation of the playlist hosted by the second electronic device 200-2.

In some implementations, the one or more memories 250B store computer program code, which, when run by the one or more processors 250A causes the wearable device 200-1′ to receive (e.g., through the communications interface 250C) an ACK signal from either or both of the first and second electronic devices 200-1 and 200-2, the ACK signal being indicative of the second electronic device 200-2 having approved the request for authorization to control the manipulation of the playlist hosted by the second electronic device 200-2.

In some implementations, the one or more memories 250B store computer program code, which, when run by the one or more processors 250A causes the wearable device 200-1′ to receive (e.g., through the communications interface 250C) a NACK signal from either or both of the first and second electronic devices 200-1 and 200-2. The NACK signal is indicative of the second electronic device 200-2 having rejected the request for authorization to control the manipulation of the playlist hosted by the second electronic device 200-2.

In some implementations, the one or more memories 250B store computer program code, which, when run by the one or more processors 250A causes the wearable device 200-1′ to enable the UI of the wearable device 200-1′ to present the playlist hosted by the second electronic device 200-2 for subsequent manipulation.

The present disclosure has presented methods in a media streaming context wherein it is made possible to operate a wearable device 200-1′ that is communicatively connected (e.g., paired via Bluetooth) to a first electronic device 200-1 to manipulate media items hosted by a remote (e.g., yet nearby) second electronic device 200-2 (e.g., to influence the order in which media items of a playlist hosted by the second electronic device 200-2 are played). Various embodiments described hereinabove thus enable a user of a wearable device, e.g. a computerized wristwatch or wristwatch-like device, to remotely control a queue of playable media items (e.g., songs) of a playlist, which is associated with a different, i.e. a second, electronic device. The authorization to control the playlist using the wearable device is determined based on the proximity between the second electronic device and a first electronic device to which the wearable device is associated, in accordance with some embodiments. Embodiments described hereinabove thus enable a user of the wearable device to control another user's playlist when these users (and their respective electronic devices) are proximate to one another. If several users are located within a certain proximity, all these users may be allowed to control, and thus influence, a common playlist that is typically hosted by an electronic device belonging to a host of a social gathering. This, in turn, may lead to improved user experiences at social gatherings, such as parties.

Some embodiments herein allow for enhanced user experiences at social gatherings such as parties by allowing a group of people to collaboratively and seamlessly live-queue favorite media items (e.g., songs) in a common playlist hosted by an electronic device associated with one of the users at the social gathering.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the described embodiments. Similarly, it will be appreciated that any flow charts and the like represent various processes which may be substantially represented in a computer readable medium (e.g., a non-transitory computer-readable medium) and so executed by a computer or processor, whether or not such computer or processor is explicitly shown. The functions of the various elements including functional blocks, may be provided through the use of hardware such as circuit hardware and/or hardware capable of executing software in the form of coded instructions stored on the above-mentioned computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while certain gestures (e.g., hovering gestures, press gestures, and tap gestures) have been described to exemplify some embodiments, other conceivable gestures also exist (e.g. flick gestures, swipe gestures, swipe-and-hold gestures, release-of-hold gestures) that could be contemplated when reducing embodiments described herein into practice. Still further, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

What is claimed is:

1. A method of controlling the manipulation of a playlist hosted by a second electronic device that comprises a processor and a memory storing instructions for execution by the processor, the method being performed by the second electronic device and comprising:
accessing geographic information that is indicative of a geographic location of a first electronic device;
determining, based on the geographic information, whether the first and second electronic devices are located within a defined geographic proximity; and
in response to a determination that the first and second electronic devices are located within the defined geographic proximity, authorizing the first electronic device to manipulate the playlist.

2. The method of claim 1, further comprising, after authorizing the first electronic device to manipulate the playlist:
generating an updated order of media items in said playlist in response to receiving a request from the first electronic device to manipulate the playlist.

3. The method of claim 1, wherein accessing geographic information that is indicative of the geographic location of the first electronic device comprises:
sensing that the first electronic device is located within the defined geographic proximity.

4. The method of claim 3, further comprising, after authorizing the first electronic device to manipulate the playlist:
generating an updated order of media items in the playlist in response to receiving a request from the first electronic device to manipulate the playlist.

5. The method of claim 3, wherein sensing that the first electronic device is located within the defined geographic proximity comprises utilizing a wireless communication technology.

6. The method of claim 5, further comprising, after authorizing the first electronic device to manipulate the playlist:
generating an updated order of media items in the playlist in response to receiving a request from the first electronic device to manipulate the playlist.

7. The method of claim 5, wherein sensing that the first electronic device is located within the defined geographic proximity comprises using Bluetooth proximity sensing technology.

8. The method of claim 7, further comprising, after authorizing the first electronic device to manipulate the playlist:
generating an updated order of media items in the playlist in response to receiving a request from the first electronic device to manipulate the playlist.

9. The method of claim 5, wherein sensing that the first electronic device is located within the defined geographic proximity comprises using Wi-Fi proximity sensing technology.

10. The method of claim 9, further comprising, after authorizing the first electronic device to manipulate the playlist:
generating an updated order of media items in the playlist in response to receiving a request from the first electronic device to manipulate the playlist.

11. The method of claim 1, further comprising, prior to authorizing the first electronic device to manipulate the playlist:
receiving, from the first electronic device, a signal being indicative of the first electronic device requesting authorization to control the manipulation of the playlist.

12. The method of claim 11, further comprising:
in response to detecting a first control gesture at a user interface of the second electronic device, interpreting the first control gesture to be an instruction to approve the request of the authorization to control the manipulation of the playlist, wherein authorizing the first electronic device to manipulate the playlist is performed in response thereto.

13. The method of claim 12, wherein the first control gesture is a tap gesture, a swipe gesture, or a hovering gesture.

14. The method of claim 12, wherein the second control gesture is a tap gesture, a swipe gesture, or a hovering gesture.

15. The method of claim 1, wherein the second electronic device is selected from the group consisting of a mobile phone, a smart phone, a tablet computer, a media player, and a desktop computer.

16. The method of claim 15, wherein the first electronic device is selected from the group consisting of a mobile phone, a smart phone, a tablet computer, a media player, and a desktop computer.

17. A second electronic device, comprising:
a user interface;
a communications interface;
one or more processors; and
a memory storing instructions, executable by the one or more processors, for:
hosting a playlist;
accessing geographic information that is indicative of a geographic location of a first electronic device;
determining, based on the geographic information, whether the first and second electronic devices are located within a defined geographic proximity; and
in response to a determination that the first and second electronic devices are located within the defined geographic proximity, authorizing the first electronic device to manipulate the playlist.

18. A non-transitory computer-readable storage medium storing one or more sets of instructions, executable by one or more processors of a second electronic device, for:
hosting a playlist;
accessing geographic information that is indicative of a geographic location of a first electronic device;
determining, based on the geographic information, whether the first and second electronic devices are located within a defined geographic proximity; and
in response to a determination that the first and second electronic devices are located within the defined geographic proximity, authorizing the first electronic device to manipulate the playlist.
